(19) United States
(12) Patent Application Publication
(10) Pub. No.: US 2002/0118808 A1
(43) Pub. Date: Aug. 29, 2002

(54) Conference system

(76) Inventors: David Wayne Kelleher, Huntington Beach, CA (US); Victor Elliot Friedberg, San Francisco, CA (US); Vincent Anthony Longobardo, Berkeley, CA (US)

Correspondence Address: JANAH & ASSOCIATES, INC., Suite 106, 650 Delancey Street, San Francisco, CA, 94107, US

(21) Appl. No.: 09/792,513

(22) Filed: Feb. 23, 2001

(51) Int. Cl. H04M 3/42; G10L 19/02

(52) U.S. Cl. 379/202.01; 379/204.01; 704/204

(57) ABSTRACT

A method and apparatus to connect a group of users via a communications network for a conference call. An initializing signal from an initializing user is detected and the initializing user is allowed to select a predefined user group. The user group comprises a list of users and their associated phone numbers that is created by a user using an user interface of a web portal and stored in a web portal database. After the selected user group is retrieved the availability of each user listed in the user group, for a conference call, is determined by connecting to each user via a communications network, announcing the initializing user to the connected user, and requesting a response from the connected user to determine if the connected user is available for the conference call. The available and connected users are interconnected with one another to allow the users to communicate in a conference call.

### BACKGROUND

Embodiments of the present invention relate to conference calls between groups of people.

Conference calls are being found increasingly useful both in business and personal communications. In a conference call, a group of users are connected to one another via a communication link so that the connected users can communicate with one another. The communications may be voice or data communications over a switched network, for example, in the form of telephone communications or packet-enabled communications over the world wide web. Conference calls are advantageous because they allow users at different locations to communicate with one another in real time and without physically relocating to a common location.

Conventional telephone systems allow the placement of a conference call amongst a group of telephone users. In one type of conference calling system, after a first user is connected to a second user, the first user places the second user “on hold,” and thereafter dials a third user to add the third user to the conference call. In this manner, several users can be sequentially connected to one another. However, each user has to wait on “hold” while the additional users are being dialed. Also, the connected users have to remain on hold until the dialing user has contacted and verified the availability of the other user. The extended delays and hold periods that result during setup of the conference call are unacceptable both in personal and business communications.

In another type of conference system, a conference-initializing user sets up a conference call with an external agency, such as a telephone operator. In the setup process, the initializing user instructs the telephone operator as to the time of the conference call as well as the phone numbers of the other conference users. At the requisite time, the telephone operator dials each of the conference users, determines their availability, places them on hold until all the conference users are reached, and thereafter, links the conference users to one another for the conference. However, such systems are disadvantageous because the telephone operator is needed and because the initializing user has to setup the conference each time.

Thus it is desirable to have a conference system that allows a user to set up a telephone conference without the assistance of the telephone operator. It is further desirable to have a conference system that retains information regarding group users as well as the telephone numbers. It is also desirable to have a conference system that can connect conference users without extensive wait or hold periods.

### SUMMARY

A method of connecting a group of users via a communications network for a conference call, the method comprising detecting an initializing signal from an initializing user, allowing the initializing user to select a predefined user group, the user group comprising a list of users and their associated phone numbers, accessing a web portal database to retrieve the selected user group, determining the availability of each user listed in the user group for a conference call by (i) connecting to each user via a communications network, (ii) announcing the initializing user to the connected user, and (iii) requesting a response from the connected user to determine if the connected user is available for the conference call, and interconnecting the available and connected users to allow the users to communicate in a conference call.

An apparatus capable of connecting a group of users via a communications network for a conference call, the apparatus comprising a conference calling system to place a conference call via a communications network, the conference calling system comprising a conference calling server connected to the communications network via a bridge and hub, and a web portal system comprising program code operating on a web portal server to maintain a web portal that is accessible by a user, the web portal capable of detecting an initialization signal from an initializing user, allowing the initializing user to select a predefined user group comprising a list of users and their associated phone numbers, accessing a web portal database to retrieve the selected user group, communicating with the conference calling system to connect to the users listed in the user group via the communications network, determine the availability of each user listed in the user group for a conference call by announcing the initializing user to each connected user and requesting a response from the connected user to determine if the connected user is available for the conference call; and receiving the responses from the connected users and communicating with the conference calling system to connect available and connected users to allow the users to communicate in a conference call.

### DRAWINGS

FIG. 1 is a block diagram of a conference system according to an embodiment of the present invention;

FIG. 2 is graphical representation of an exemplary screen for creating the user groups;

FIG. 3 is a flowchart showing the steps of initiating and performing a conference call according to the present invention; and

FIG. 4 is a flowchart showing a logical flow sequence of an embodiment of a conference system according to the present invention.

### DESCRIPTION

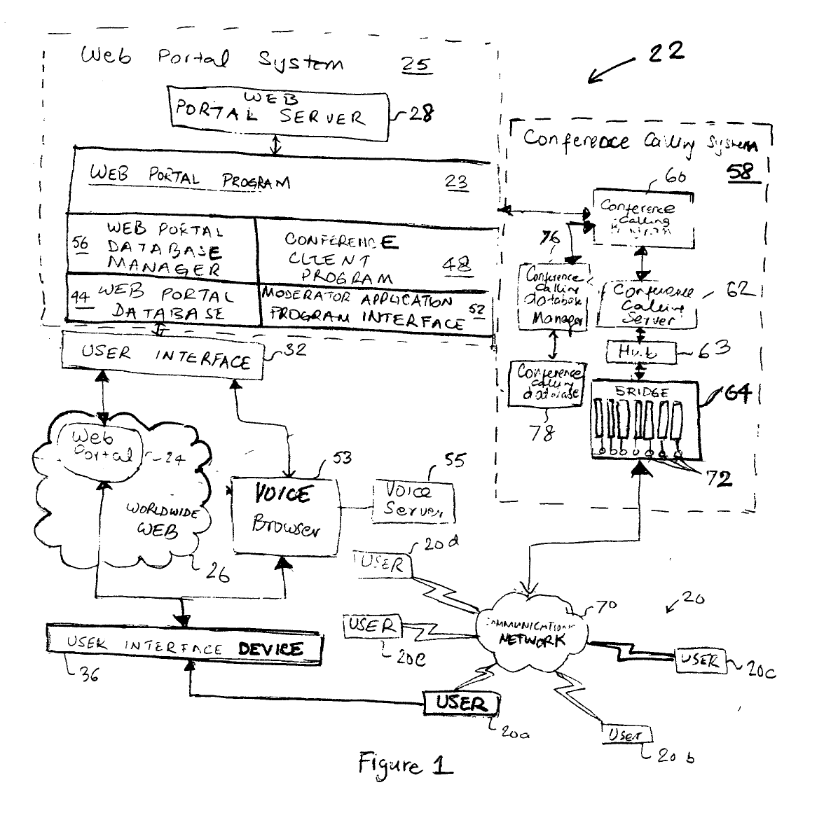

Embodiments of the present invention facilitate voice, data or graphical conferencing between a group of users 20, such as the users 20a-e, to the conference system 22. A block diagram of a conference system 22 according to an embodiment of the present invention is illustrated in FIG. 1. In operation, an initializing user 20a operates a user interface device 36 to access a web portal 24 on the world wide web 26. The user interface device 36 may include, for example, a telephone, computer terminal or web-accessing device. The web portal 24 is maintained by a web portal system 25 comprising a web portal program 23 that is operated on one or more web portal servers 28. For example, a suitable web server 28 may be computer with 32GB HDD, 512 MB RAM, 2 Intel Pentium III central processor units (CPU's) and having web-hosting software, such as for example, an Apache web server software of Apache Software Foundation, which may be operated on an operating system, such as Windows NT (TM) Microsoft Corp, Seattle, Wash.

The web portal program 23 comprises program code for operating the web portal 24, receiving signals from the user via the world wide web 26, and displaying screens to the user 20a. The web portal program 23 and other programs described herein may be created using conventional programming languages, such as JAVA, XML (extensible markup language), and HTML (hypertext markup language).

The web portal program 23 provides to the user 20a, via the web portal 24 on the world wide web 26, a user interface 32 that allows communications between the user 20a and the web portal program 23. The user interface 32 displays and receives data from the user 20a. A suitable user interface 32 may be a data user interface (DUI), voice user interface (VUI), or graphical user interface (GUI). The user interface 32 is passed through an interpreter which is a program that executes instructions written in a high-level language. The interpreter translates high-level instructions into an intermediate form, which it then executes. While a compiler may also be used, the advantage of an interpreter, however, is that it does not need to go through the compilation stage during which machine instructions are generated. This process can be time-consuming if the program is long. The interpreter, on the other hand, can immediately execute high-level programs. Each different type of interface requires its own interpreter. For example, a GUI written in HTML requires an HTML browser. A DUI requires a WML/HDML browser. A VUI requires a voice browser 53 which may be written in voXML or VoiceXML, and which is resident on a voice processing server 55, such as for example, a web based personal assistant that invokes a MIX (Mobile Internet Exchange) platform from Motorola Inc, Chicago, Ill.

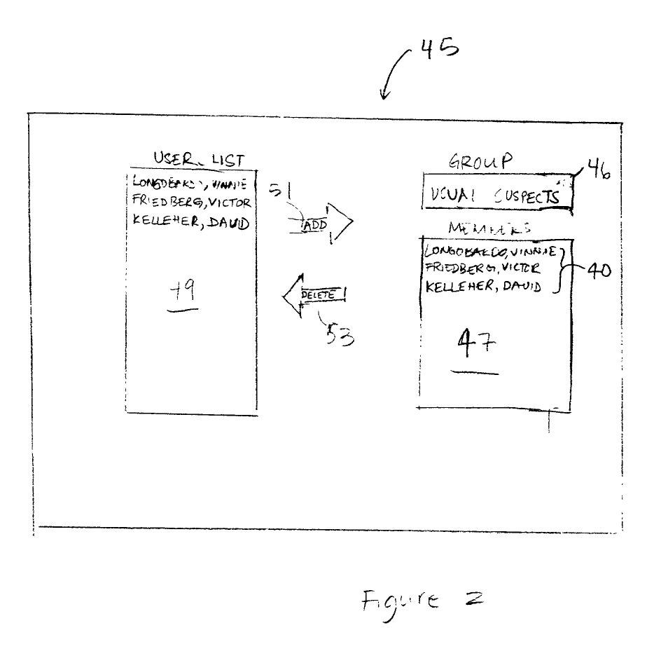

Using the user interface 32, the initializing user 20a creates one or more user groups 40. For example, the user interface 32 may provide a GUI template 45 to enter the data to form the user groups 40, as shown in FIG. 2. The GUI template 45 allows each user 20 to define his/her own groups and add, delete and modify any of the groups 40. A suitable GUI template 45 contains data entry fields to enter, for example, a user group name, one or more users and their associated phone numbers, and other such information. A suitable template 45 comprises, for example, a group name box 46 to name the group, a group user box 47 to list the users in the group, and a user list box 49 that provides a list of users associated with the user or which the user manually enters, from which the group users may be selected. The individual users are defined in a separate data fields that contain more detailed information about each of the users. Graphical icons representing the “Add” and “Remove” functions 51, 53, respectively, are provided to transfer user names to the group being created or to delete user names from the group. Each user group 40 comprises a list of users, and each user in the list may be associated with one or more of their telephone numbers, and other data fields. Each user group 40 may contain, for example, from 2 to 8 users, or even 6 users, and may include the user who set up the list. Any one of the listed users in a group 40 can be a conference call initializing user 20a.

The user defined user groups 40 are stored in an user address book linked to the originating user 20a and residing on a web portal database 44 operated by a web portal database manager 56. Typically, the web portal database 44 and web portal database manager 56, form a relational database structure comprising program code that retrieves and stores any entered data, such as user login and password, user information, user listed users, and user defined groups. A suitable database application is SQL from Microsoft Corporation.

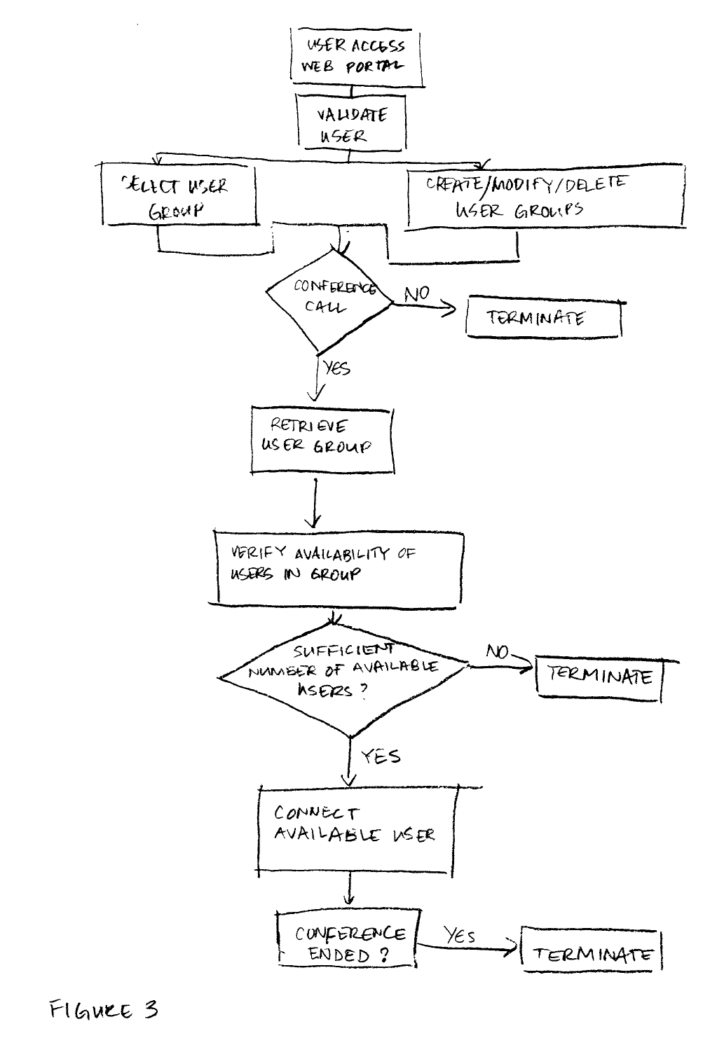

A flow chart of an embodiment of the conferencing system 22 is shown in FIG. 3. To operate the conference system 22, an initializing user 20a invokes the user interface 32 via a user interface device 36, such as a telephone or a computer, and enters an initializing signal, such as a user identification (ID) and password, which are used to validate the user 20a and provide access to the user's predefined user groups. The data entry mode of the user ID, password and command entries depend upon the type of user interface device 36 used by the user 20a, whether voice, graphic or data. For example, when using a voice-type user interface device 32, such as a mobile phone, the initializing user 20a dials their own phone number, for example, by pressing the voice mail key on the phone. After a voice browser 53 answers the phone, the initializing user 20a issues a voice command, saying for example, “dkode,” at which the voice server 55 routes the user 20a to the web portal server 28. Once the initializing user 20a is on the web portal server 28, an voice announcement is played that says “You're on dkode mobile. If you're ready to blast, say blast, if not say quit it to exit or goodbye to get out”. The initializing user 20a then says another command to start the conference call process, for example, “Blast”, at which the web portal server 28 responds with “Blast which group?” The initializing user 20a then says the name of one of their groups 40, for example, “party line” to initiate a conference call to a user group called “party line,” or by saying for example, “call the band” to initiate a conference call to a user group called the “the band.” The user interface 32 may also play various error messages including one that lists the names of the groups 40 if the user 20a says a name that is not in the web portal database 44. Once a group name is recognized, the user interface 32 responds with “Blasting, please hang up now” and then effects the conference call. The user 20a can also initiate the conference call by a data command on a data entry based user interface device 36, such as a mobile web browser, by entering the correct data in the data fields; or by a graphic command on a user interface device 36, such as a desktop computer, into a GUI accessed through the web portal 24, for example, by clicking a mouse on an icon such as a blast icon, or an individualized icon such as the aforementioned “party line,” or by dragging a group icon into a virtual telephone booth graphical image. In the GUI version, the GUI may provide a sequence of visual screens to represent the initialization and performance of the conference call.

Upon entry of a valid user ID and password, the web portal program 23 invokes a conference client program 48 by passing an initialization signal to the conference client program 48, for example, a signal comprising the user ID of the initializing user 20a to initiate the conference call. While provisioning for a user in the conference system 22 an entry is created in a user table of the web portal database 44 for a user name to be associated with a user ID and password to allow a named user access to an associated user address book. The entered user ID and password are used by the conference client program 48 to validate the initializing user 20a into the conference system 22 to initiate a conference call. Any one of the listed users of a group 40 may access the conference system 22 and conference call the other listed users. The user address book contains the user created data, such as the listed users and groups 40 created by the user 20a and may be used to select a group, create a new group, modify an existing group, or delete a group. A database entry may also be created to associate a predefined location for each user. For example, a city, such as Sacramento, may also be associated with the user. This forms a key in another database table which is used by the conference client program 48 to identify the internet protocol (IP) address and port of the web portal server 28 where the call is to be initiated, for example, when multiple servers are used in the conference system 22.

The conference client program 48 also provides a common application programming interface to the user interface 32. The conference client program 48 detects the initializing signal and internally logs-in the user 20 as a valid or invalid user on the conference system 22 by extracting the user ID and password from the web portal database 44. A properly logged-in initializing user 20a is then allowed to select a conference option and a particular predefined user group 40 out of a number of user groups 40 in the personal address book of the user 20a. The initializing user 20a is also notified via the user interface 32 to hang up the telephone line, if they dialed into the system 22 using the same phone that they will receive the conference call on, so that the user 20a can also be dialed back into the conference system 22. The conference client program 48 then invokes the database manager 56 to retrieve the user define group and receive the list of phone numbers of the individual users 20a-e to be dialed into for the conference call.

Typically, the conference call is initiated immediately upon the conference client program 48 receiving the necessary information. This “hot” initialization setup is desirable to instantaneously conference call all the other users listed in the group. However, the conference call may also be initiated at a set time or after a set time period, as defined by the initializing user 20a in the user interface 32. To verify the availability of the users defined in the group and to initiate the conference call, the conference client program 48, via a moderator application programming interface 52, sends a request to a conference calling system 58 comprising a conference calling program 60 operating on a conference calling server 62. The moderator application programming interface 52 is an interfacing program that allows communications between the conference client program 48 and the conference calling server 62. Generally, the conference calling server 62 comprises a suitable general purpose computer, such as a Sun Sparc Ultra 5 with a Sun Solaris 8 operating environment. A suitable conferencing calling program 60 is the Conference Now!™ system available from Voyant, Inc., Westminster, Colo. The conferencing calling program 60 on the conferencing calling server 62 communicates through a hub 63 to a bridge 64 that is connected to a communications network 60 to place the conference call. The hub 63 serves as a distribution point in the network and it accepts a signal from one point and redistributes it to one or more points. The bridge 64 is a device that (a) links or routes signals from one ring or bus to another or from one network to another. Generally, the bridge 64 does not modify the packets or messages, sent through to the communications network 70 and operates at the data-link layer. The bridge 64 initiates the conference calls through suitable communication lines, for example, DSL or T1 lines, to connect individual users into the conference call. A suitable bridge 64 may be, for example, a 24 port bridge. The bridge 64 communicates with the communications network 70 via a T1 line, which designates a digitally multiplexed telecommunications carrier line, such as a 2 span T1 line. The number of simultaneous conference calls is limited by the number of bridge ports 72, because each bridge port 72 maps to a communication line, such as a T1, ISDN or other line, of a communication network 70, that maps to a user 20.

The conference calling program 60 accesses the communications network 70 to place the conference calls. Generally, the communications network 70 is a network capable of providing switched communications services, in which a user 20a-e may be connected to any other user 20a-e through the use of data transmission via message, circuit, or packet switching. For example, a suitable communications network 70 may be a public switched telephone network (PSTN) comprising a common carrier network that provides circuit switching among public users 20a-e, and is typically operated by a telephone company, such as US Sprint or AT&T. Another suitable communications network 70 is a packet switching network (PSN) which operates by sending data packets over a network of interconnected electrical lines, and for example, allows voice over IP (VOIP), voice over frame relay (VOFR), voice over packet data (VOPD), video over packet data, packet data network (PDN) and the like.

The conference calling program 60 also has access to a conference calling database manager 76 and conference calling database 78 that is stored on the conference calling server 62 and may be used to maintain additional user information, such as the names and phone numbers of all the users. A conference call is initiated by the conference client program 48 using the phone numbers of the users 20a-e listed in the requested user group 40 that are to be dialed into the conference. The conference program 48 connects to each listed user 20a-e in a user group 40 by dialing a phone number associated with the user 20a-e. The conference call may be initiated by a simple dial-out in which the system dials out one user at a time, or for faster conference initiation speed, by a multiple-dialing system that dials all the users simultaneously.

After each listed user 20a-e is connected via a telephone, the conference client program 48 determines the availability of the user 20a-e by requesting a predefined response from the user. The conference client program 48 also checks for busy telephone lines or voicemails to disconnect the user 20a-e. If the telephone line of a listed user is busy the user is not entered into the conference call. If the user 20a-e does not answer the telephone call, for example, when the call is transferred to an answering machine or voicemail, the conference client program 48 detects this and disconnects the user 20a-e from the conference call. This may be achieved by requesting a response from the contacted user, for example, requesting the user to press a telephone digit number to enter the conference call. If the user 20a-e does not respond, the conference client program 48 retries the user request. On two unsuccessful attempts, the conference client program 48 assumes that the conference call has been transferred to voicemail and disconnects the telephone line. This sequence is performed for all the other listed users in the group 40, until they are all either connected or determined to be unavailable.

The conference client program 48 also announces the initializing user 20a to the other connected users 20b-e when soliciting their response. The conference client program 48 does this to ensure that the user 20b-e wants to receive the phone call and is not surprised when connected to the initializing user 20a or the other users 20b-e of the user group 40. In the announcement, the conference client program 48 may also announce that it is a conference call, for example, by announcing a predefined word set to each of the users 20a-e. The entire announcement may thus read, for example, “This is a blast from [user name of initializing user 20a]— if you are available press 1.” In this announcement, the word “blast” is used to designate the conference call.

The response provided by each of the connected users 20a-e may also be fed back to the conference client program 48 via the conference calling server 62. The conference client program 48 then sends a success/failure message back to the user interface 32 which would then respond appropriately to the initializing user 20a via data signals, voice signals or graphical images. Depending on whether a user 20a-e is busy, unavailable, or available, the conference client program 48 returns an appropriate status code for the success or error to the user interface 32. The busy or unavailable user is logged off by the conference client program 48 when the conference is ended.

The conference client program 48 also determines if a sufficient number of users are available for the conference call, typically a predefined number, such as for example, 2 or 3. If a conference can be conducted, the conference client interconnects the available users 20a-e to allow the users to communicate with one another. The conference is terminated when all the conference users 20a-e hang up, if none of them other than the initializing user are available, or if less than a predefined number of users are available.

Typically, the users 20a-e communicate via voice communications, however, other forms of communication, such as data, graphical or video communications may also be used. In a preferred version, the users 20a-e communicate via a telephone, such as a mobile phone, and the conference system 22 initiates the conference call between the different users as soon as one of the users activates the system via their mobile phone. This version allows the available users 20a-e of a predefined user group 40 to instantly access one another to chat, gossip or for business purposes. The instant conference calling version is particularly appealing to teenagers who want to chat in a group without extensive dialing and phone connection efforts. It may also be used by TV personnel to instantly connect to a team of camera operators, scripters, and TV journalists, to assemble the team and cover a “live” event with urgency. As another example, the instant conference call system may also be used by business managers to instantly assemble their team to communicate or discuss new developments.

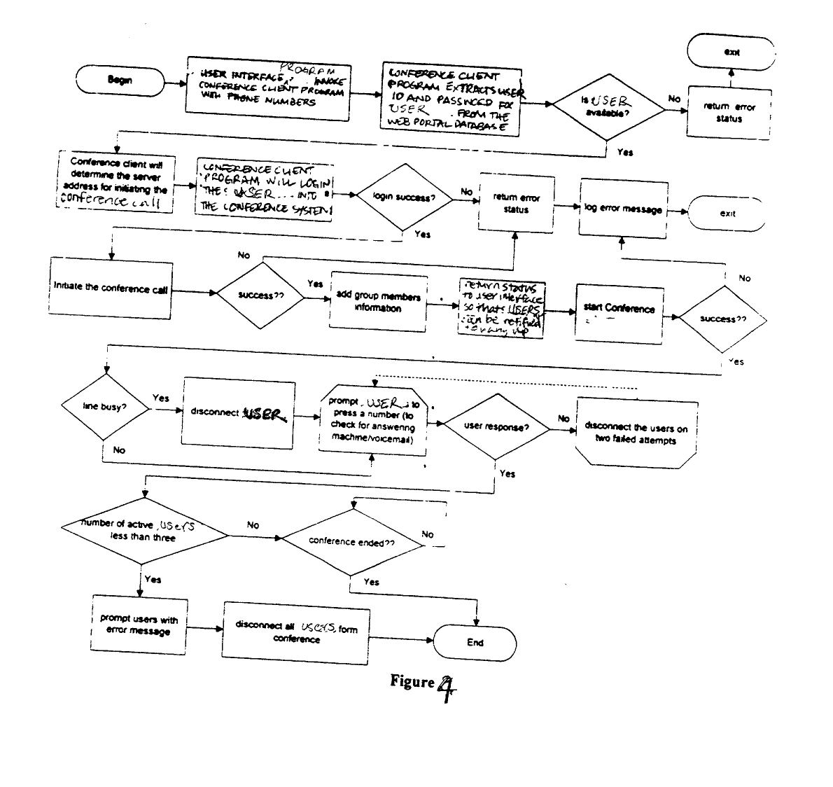

FIG. 4 is a flowchart showing a more detailed logical flow of an embodiment of the present conference system 22. It starts with the user interface 32 receiving a user ID and password from an initializing user 20a accessing the conference system 22. The user interface 32 then invokes the conference client program 48 to extract the user ID and password from the web portal database 44 to determine if the user is a valid user to conference system 22. The conference ends either at an error condition or when the conference successfully terminates. The user interface 32 also returns appropriate status code and throw exceptions to the user 20a. For example, the user interface 32 may receive input data and commands as follows:

“short StartConference(string subld, string phoneNos[]) throws exceptions” where the “subid” parameter indicates the user id of the initializing user 20a that initiates the conference call. The second parameter “phoneNos” is an array of strings that will contain a list of phone numbers to be dialed into the conference.

The user interface 32 also returns the Success/Failure return status code depending on the status of the conference call. If the conference call is successfully initiated the program will return the number of conferees. If the conference call fails the program will return “−1”.

The user interface 32 may also throw appropriate exceptions to indicate the reason for the failure if it is unable to start the conference call, as provided below. In case of failure, the exceptions may indicate the error/problem to initiate the conference call. For example, the application program interface may throw the following list of exceptions to the user 20 interface.

1. An “InternalErrorException” when it is unable to initiate the conference due to internal system error. The internal error can be due to (i) errors due to unsuccessful Login into the conference calling program 60, (ii) errors due to network problems between conference calling program 60 and the conference client program 48, (iii) errors due to malfunctioning of the bridge 64, or (iv) errors in starting the conference. An “errorMsg” string contains the error information and the user interface program 32 returns the system error message to the user 20a.

2. A “PortsNotAvailableException” when the number of conference calls on the system 22 reach the maximum limit and not enough ports 72 are available to start a new conference call. In this case the user interface 32 will return appropriate message to the user 20a to try to try the conference call later.

3. A “LessThanThreeUsersException” when the number of users 20a-e that are available to participate in the conference call is less than three, or some other predesignated number. This may happen if some of the listed users 20a-e have their phone lines busy or the conference call reaches their voicemails. The conference system 22 then disconnects the already connected users 20a-e. This exception may also contain an array of phone numbers that were successfully brought into conference, which for example, may be a maximum of two numbers. The user interface 32 may then respond to the user 20a with an error message indicating that not enough users 20a-e could be successfully dialed into the conference and give the numbers/names of users 20a-e that could be dialed into the conference.

4. The conference client program 48 may also have logging and error handling capabilities incorporated in two ways, namely, “Run time error handling” and “Static error handling.” Run time error handling is performed to trap system/other errors and log the message in the web portal database 44 for technical support reference. This is achieved by the return value and exceptions thrown by the conference client program 48. Based on the return values and exceptions the user interface program 32 will send an appropriate message to a user 20a-e. An example of run time error handling is when a user 20a initiates a conference and all the ports 72 are busy. In this case the conference client program 48 throws an exception indicating this to the user interface 32. The user interface 32 will then format an appropriate message like “All lines are busy. Please try after sometime” and send it to the database manager 56 which will log the error into the database 44.

5. A static error handling message is provided when the conference system 22 “panics”, goes down or is unable to recover from errors. A static error may require manual intervention. The conference client program 48 may generate log files as described above with various error levels of logging. When the system 22 starts behaving abnormally, a system administrator can investigate the log files. If required, the conference client program 48 can be set at a higher level of logging to identify the exact cause of error and fix it.

An exemplary high level pseudo code for the client conference program 48 is detailed below. The example provided only denotes the high level code architecture and logical flow and does not cover detailed class description, code, or error handling details. Actual program code may be split in multiple files or classes and may also include logging and error handling.

Begin

Create an object to handle messages from the web portal server.

Create an object to send messages to web portal server.

Connect and login to the web portal server.

If Login Success

Start conference.

If conference started successfully

Create user object for each user using the user info.

Assign available port to each user object

If no port is available

Wait and try assigning port again.

If Port is available

Dial out to the user.

If Success

Repeat for all other users of the listed users.

Else

If only two users 20 are connected in conference

Throw LessThanThreeUsersException

End

Else

Throw PortsNotAvailableException

End

Else

Throw lnternalErrorException(“Unable to make conference call”);

End

End if

Else

Throw InternalErrorException(“Unable to login to the server”);

End

End if

End.

Although the present invention has been described in considerable detail with regard to certain preferred versions thereof, other versions are possible. Furthermore, although the described invention is particularly useful in connecting a group of users via the web, it may also be used to connect users via other systems and for other applications. Therefore, the appended claims should not be limited to the description of the preferred versions and uses contained herein.

What is claimed is:

1. A method of connecting a group of users via a communications network for a conference call, the method comprising:
(a) detecting an initializing signal from an initializing user;
(b) allowing the initializing user to select a predefined user group, the user group comprising a list of users and their associated phone numbers;
(c) accessing a web portal database to retrieve the selected user group;
(d) determining the availability of each user listed in the user group for a conference call by (i) connecting to each user via a communications network, (ii) announcing the initializing user to the connected user, and (iii) requesting a response from the connected user to determine if the connected user is available for the conference call; and
(e) interconnecting the available and connected users to allow the users to communicate in a conference call.

2. A method according to claim 1 wherein (e) comprises determining if a minimum number of users are available for the conference call before interconnecting the available users.

3. A method according to claim 1 wherein (a) comprises validating the identity of the initializing user.

4. A method according to claim 3 wherein (b) comprises allowing the validated user access to one or more predefined user groups that are associated with the validated user.

5. A method according to claim 4 comprising initially providing a web portal template for a user to define a user group and saving the defined user group in the web portal database.

6. A method according to claim 1 wherein (d)(i) comprises connecting to a user by dialing a phone number associated with the user in the user group.

7. A method according to claim 1 wherein (d)(ii) comprises providing an predefined code word before or after announcing the name of the initializing user to a connected user.

8. A method according to claim 1 wherein d(iii) comprises requesting the connected user to press a telephone digit.

9. A method according to claim 1 wherein (d) comprises repeating steps (i) to (iii) more than once for each user.

10. A method according to claim 1 wherein the user group includes the initializing user.

11. A method according to claim 1 wherein in (d) the users communicate via voice communications.

12. An apparatus capable of connecting a group of users via a communications network for a conference call, the apparatus comprising:
(a) a conference calling system to place a conference call via a communications network, the conference calling system comprising a conference calling server connected to the communications network via a bridge and hub; and
(b) a web portal system comprising program code operating on a web portal server to maintain a web portal that is accessible by a user, the web portal capable of:
(i) detecting an initialization signal from an initializing user,
(ii) allowing the initializing user to select a predefined user group comprising a list of users and their associated phone numbers,
(iii) accessing a web portal database to retrieve the selected user group,
(iv) communicating with the conference calling system to connect to the users listed in the user group via the communications network,
(v) determine the availability of each user listed in the user group for a conference call by announcing the initializing user to each connected user and requesting a response from the connected user to determine if the connected user is available for the conference call; and
(vi) receiving the responses from the connected users and communicating with the conference calling system to connect available and connected users to allow the users to communicate in a conference call.

13. An apparatus according to claim 12 wherein the web portal is capable of determining if a minimum number of users are available for the conference call before interconnecting the available users.

14. An apparatus according to claim 12 wherein the web portal is capable of validating the identity of the initializing user.

15. An apparatus according to claim 14 wherein the web portal is capable of allowing the validated user access to one or more predefined user groups that are associated with the validated user.

16. An apparatus according to claim 15 wherein the web portal is capable of providing a template for a user to define a user group and saving the defined user group in the web portal database.

17. An apparatus according to claim 16 wherein the communications network connects to each user defined in the user group by dialing a phone number associated with the user.

18. An apparatus according to claim 12 wherein the web portal is capable of providing a predefined code word before or after announcing the name of the initializing user to a connected user.

19. An apparatus according to claim 12 wherein the web portal is capable of requesting a response from the connected user by requesting the connected user to press a telephone digit.

20. An apparatus according to claim 12 wherein the web portal is capable of repeating step (v) more than once for each user.

21. An apparatus according to claim 12 wherein the users are connected to one another by the communications network to allow the users to communicate via voice communications.
